(19) United States
(12) Patent Application Publication
(10) Pub. No.: US 2025/0287137 A1
(43) Pub. Date: Sep. 11, 2025

(54) ANC SYSTEM FOR EARPHONE, NOISE CANCELLATION METHOD, AND STORAGE MEDIUM

(71) Applicant: Bestechnic (Shanghai) Co., Ltd., Shanghai (CN)

(72) Inventor: Qian LI, Shanghai (CN)

(73) Assignee: Bestechnic (Shanghai) Co., Ltd., Shanghai (CN)

(21) Appl. No.: 19/220,776

(22) Filed: May 28, 2025

Related U.S. Application Data
(63) Continuation of application No. PCT/CN2023/103753, filed on Jun. 29, 2023.

(30) Foreign Application Priority Data
Dec. 23, 2022 (CN) 202211666838.5

(51) Int. Cl. H04R 1/10

(52) U.S. Cl. CPC H04R 1/1083

(57) ABSTRACT

The present disclosure relates to an ANC system for an earphone, a noise cancellation method, and a storage medium. The ANC system comprises a system-on-chip comprising a processor. The processor is configured to: obtain a noisy signal collected by a feedforward microphone; filter the noisy signal using a trained neural network filter containing an ESN to output a filtered first signal, and retrain the ESN when a first preset condition is met, wherein the first preset condition at least includes a change in a wearing manner or a leakage amount of the earphone during use; and generate a noise cancellation signal based on the first signal, the noise cancellation signal is adapted to be played via a speaker to cancel residual noise of the earphone in an ear.

### CROSS-REFERENCE TO RELATED APPLICATIONS

This application is a continuation of International Application No. PCT/CN2023/103753, filed on Jun. 29, 2023, which claims the benefit of priority to Chinese Application No. 202211666838.5, filed on Dec. 23, 2022, both of which are hereby incorporated by reference in their entireties.

### TECHNICAL FIELD

The present disclosure relates to the field of active noise cancellation (ANC) technology, and in particular, to an ANC system for an earphone, a noise cancellation method, and a storage medium.

### BACKGROUND

With the development of technologies, ANC earphones have been widely used. However, when the ANC technology is applied to earphone products, cancellation signals with opposite phases are often generated to achieve the effect of noise cancellation. In these scenarios, a linear filter is generally used to fit a primary path system function of sound transmitted from the outside to an ear canal, but none of an earphone, a microphone, and a speaker is an ideal linear collection and playback device. Because the linear filter cannot fit the nonlinear effect of the physical device, both the noise cancellation bandwidth and the noise cancellation amount are limited, which affects the user experience.

In the prior art, the above problems are generally solved by optimizing a passive noise cancellation curve of the earphone itself and the linearity of the speaker and the microphone, and the main method is to minimize the nonlinearity and abrupt changes in the spectrum and phase of the system device through extensive testing and experiments. However, this method imposes stringent requirements on earphone cavity design. Moreover, for the ANC system, the method of optimizing the earphone cavity still has some problems. For example, extensive testing and modifications are required, making it extremely difficult to optimize the cavity nonlinearity. Moreover, the optimized earphones cannot improve the music quality. For instance, it is limited to using single-driver designs rather than dual-driver designs that improve high-frequency sound quality. In addition, during the filtering process using filters that contain Recurrent Neural Networks (RNNs), it is difficult to perform online training due to the very large scale of the RNN network, a large quantity of resources occupied, and high complexity. Further, the data sampling rate during ANC operation is relatively high, and the RNN-based approach consumes excessive power, limiting its application in earphones with high power and resource requirements.

### SUMMARY

The present disclosure is provided to solve the above problems. There is a need for an ANC system for an earphone, a noise cancellation method, and a storage medium, which are capable of performing adaptive filtering quickly and efficiently while preventing the filtering process from occupying excessive workload that could otherwise degrade the user-perceived audio quality.

According to a first aspect of the present disclosure, an ANC system for an earphone is provided. The ANC system comprises a system-on-chip comprising a processor. The processor may be configured to obtain a noisy signal collected by a feedforward microphone. The processor may be further configured to filter the noisy signal using a trained neural network filter containing an echo state network (ESN) to output a filtered first signal, and retrain the ESN when a first preset condition is met. Wherein the first preset condition at least includes a change in a wearing manner or a leakage amount of the earphone during use. The processor may be further configured to generate a noise cancellation signal based on the first signal, the noise cancellation signal is adapted to be played via a speaker to cancel residual noise of the earphone in an ear.

According to a second aspect of the present disclosure, a noise cancellation method for an ANC system is provided. The method may comprise obtaining a noisy signal collected by a feedforward microphone. The method may further comprise filtering the noisy signal by a trained neural network filter containing an echo state network (ESN) to output a filtered first signal, and retraining the ESN when a first preset condition is met. Wherein the first preset condition at least includes a change in a wearing manner or a leakage amount of an earphone during use. The method may further comprise generating a noise cancellation signal based on the first signal, the noise cancellation signal is adapted to be played via a speaker to cancel residual noise of the earphone in an ear.

According to a third aspect of the present disclosure, a computer-readable storage medium is provided. The computer-readable storage medium stores computer program instructions that, when executed by a processor, enable the processor to perform the noise cancellation method according to various embodiments of the present disclosure.

Compared with the prior art, the embodiments of the present disclosure have the following beneficial effects:

According to the ANC system for an earphone in the embodiments provided in the present disclosure, the noisy signal is filtered by the trained neural network filter containing the echo state network (ESN) to output the filtered first signal. This enables simultaneous fitting of both linear and non-linear components in the ANC system, thereby improving noise cancellation bandwidth and noise cancellation amount without requiring optimization of an earphone cavity. Moreover, the ESN employs simple linear regression to train the output weight, resulting in significantly lower network scale and complexity compared to those of RNNs and LSTMs. This enables online training with fast convergence and improves the training efficiency. In addition, the ESN is retrained when the first preset condition is met, thereby realizing online training. This enables the neural network filter to automatically adjust network parameters based on the status of the earphone, and the like, thereby enhancing the filtering effect and improving noise cancellation bandwidth and noise cancellation amount.

The above description is only an overview of the technical solutions of the present disclosure, and to enable a clearer understanding of the technical means of the present disclosure, it can be implemented according to the content of the specification. Furthermore, in order to make the above and other objects, features, and advantages of the present disclosure more obvious and comprehensible, specific embodiments of the present disclosure are particularly described below.

### BRIEF DESCRIPTION OF THE DRAWINGS

In the drawings, which are not necessarily drawn to scale, like numerals may describe similar components in different views. The drawings illustrate generally, by way of example, but not by way of limitation, various embodiments, and together with the description and claims, serve to explain the disclosed embodiments. Wherever appropriate, the same reference numbers will be used throughout the drawings to refer to the same or like parts. Such embodiments are illustrative and are not intended as exhaustive or exclusive embodiments of the present apparatus or method.

FIG. 1 (a) illustrates a structural schematic diagram of an ANC system for an earphone according to an embodiment of the present disclosure.

FIG. 1 (b) illustrates a schematic diagram of neural network training according to an embodiment of the present disclosure.

FIG. 1 (c) illustrates a structural schematic diagram of an ESN network according to an embodiment of the present disclosure.

FIG. 1 (d) illustrates a schematic diagram of the training procedure of an ESN network according to an embodiment of the present disclosure.

FIG. 1 (c) illustrates a schematic diagram of active noise cancellation performed by an ANC system for an earphone according to an embodiment of the present disclosure.

FIG. 2 (a) illustrates another schematic diagram of active noise cancellation performed by an ANC system for an earphone according to an embodiment of the present disclosure.

FIG. 2 (b) illustrates another schematic diagram of neural network training according to an embodiment of the present disclosure.

FIG. 3 illustrates yet another schematic diagram of active noise cancellation performed by an ANC system for an earphone according to an embodiment of the present disclosure.

FIG. 4 illustrates one of the schematic diagrams of active noise cancellation performed by an ANC system for an earphone according to an embodiment of the present disclosure.

FIG. 5 illustrates a flowchart of a noise cancellation method for an ANC system according to an embodiment of the present disclosure.

### DETAILED DESCRIPTION

In order to enable those skilled in the art to better understand the technical solutions of the present disclosure, the present disclosure is described in detail below in conjunction with the accompanying drawings and specific embodiments. The embodiments of the present disclosure are further described in detail below in conjunction with the accompanying drawings and specific embodiments, but are not to be construed as limiting the present disclosure. For various steps described herein, if there is no necessary sequential relationship between each other, the order in which the steps are described as examples herein should not be considered as a limitation. Those skilled in the art will understand that the sequence of the steps may be adjusted as long as such adjustments do not disrupt the logical relationships between them and render the overall process unworkable.

The terms “first”, “second”, and the like, as used in the present disclosure, do not denote any order, quantity, or importance, but rather are used to distinguish one element from another. The words “include” or “comprise” and similar expressions indicate that an element preceding the word encompasses an element listed after the word, and does not exclude the possibility of also covering other elements. In the present disclosure, arrows shown in the drawings of the steps are merely examples of an execution sequence, but are not intended to limit. The technical solutions of the present disclosure are not limited to the execution sequence described in the embodiments, and the steps in the execution sequence may be executed in combination, separately, or in a different order, provided that the logical relationship of execution content is not affected.

Unless otherwise defined, all terms (including technical and scientific terms) used in the present disclosure have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and should not be interpreted in an idealized or overly formalized sense unless expressly defined to the contrary herein. Techniques, methods, and apparatus known to those skilled in the relevant art may not be discussed in detail, but such techniques, methods, and apparatus, where appropriate, should be deemed as part of the specification.

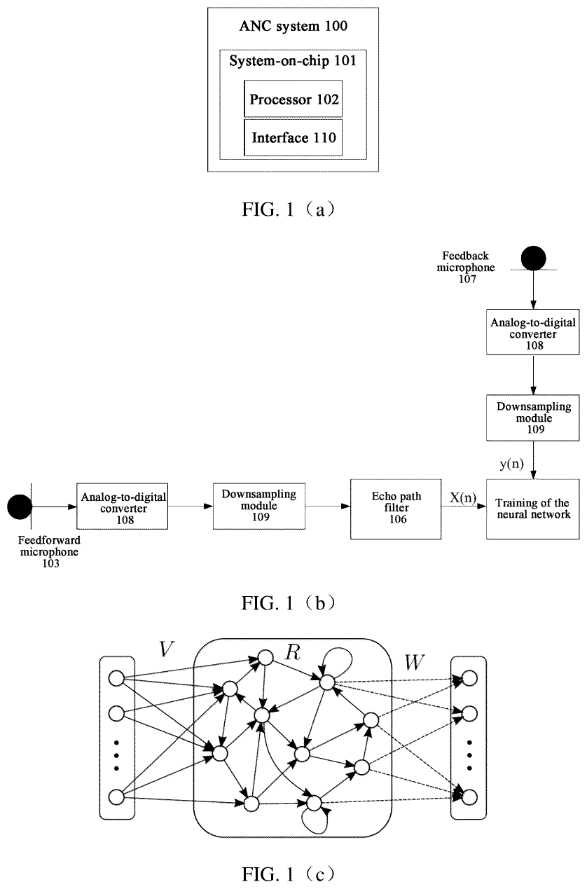

FIG. 1 (a) illustrates a structural schematic diagram of an ANC system for an earphone according to an embodiment of the present disclosure. FIG. 1 (b) illustrates a schematic diagram of active noise cancellation performed by an ANC system for an earphone according to an embodiment of the present disclosure.

According to some embodiments of the present disclosure, an ANC system 100 for an earphone is provided. The ANC system 100 comprises a system-on-chip 101 comprising a processor 102. The processor 102 is configured to obtain a noisy signal collected by a feedforward microphone 103, and filter the noisy signal using a trained neural network filter containing an echo state network (ESN) 104 to output a filtered first signal, and retrain the ESN when a first preset condition is met, wherein the first preset condition at least includes a change in a wearing manner or a leakage amount of the earphone during use, and generate a noise cancellation signal based on the first signal, the noise cancellation signal is adapted to be played via a speaker 105 to cancel residual noise of the earphone in an ear. It should be noted that, in the present disclosure, various components, for example, the processor 102 shown in FIG. 1 (a), may be implemented using an SoC (system-on-chip), for example, implemented as a system-on-chip 101. For example, various RISC (Reduced Instruction Set Computer) processor IPs purchased from ARM Corporation and the like may be utilized as the processor 102 of the SoC to execute corresponding functions, thereby enabling implementation as an embedded system. Specifically, commercially available modules (IP) have many modules, such as but not limited to a memory, a buffer, etc. In some embodiments, chip manufacturers may also autonomously develop customized versions of these modules on off-the-shelf IPs. In addition, other devices such as a limiter, a speaker, and a microphone may be externally connected to the IP. A user may build the ANC system 100 by building an ASIC (Application Specific Integrated Circuit) based on purchased IPs or autonomously developed modules, so as to reduce power consumption and cost.

The processor 102 may be a processing device comprising one or more general-purpose processing units, such as a microprocessor, a central processing unit (CPU), a graphics processing unit (GPU), or the like. More particularly, the processor 102 may be a complex instruction set computing (CISC) microprocessor, reduced instruction set computing (RISC) microprocessor, very long instruction word (VLIW) microprocessor, processor running other instruction sets, or processors running a combination of instruction sets. The processor 102 may also comprise one or more special-purpose processing devices, such as an application-specific integrated circuit (ASIC), a field programmable gate array (FPGA), a digital signal processor (DSP), a system-on-chip (SoC), or the like.

Specifically, a method for training the ESN is shown in FIG. 1 (b). In a training phase, x(n) represents a signal obtained by processing the noisy signal captured by the feedforward microphone 103 through an analog-to-digital converter 108, a downsampling module 109, and an echo path filter 106. Meanwhile, y(n) represents a noisy signal collected by a feedback microphone 107 when the ANC function is not enabled. The ESN is trained to minimize the absolute error between an output of the neural network and y(n), while maintaining opposite phase. The echo path filter 106 estimates a path from the signal played out from the speaker 105 to the feedback microphone 107. The echo path filter 106 is an estimation filter that describes the path of the sound that is played by the speaker 105 and reflected by the ear canal to the feedback microphone 107. It filters the signal from the feedforward microphone 103 using this specific function (referred to as the echo path function) to simulate the processing experienced by the signal after being played by the speaker 105 and then passing through the ear canal reflection path.

In the ESN network shown in FIG. 1 (c), the network structure consists of an input layer, a reservoir, and an output layer in sequence. Here, x(n), S(n) and y(n+L) denote the ESN network input, the network state (i.e., the state of the reservoir) and the network output at time n, respectively; while V, R and W denote the input weight, the intermediate weight and the output weight matrix, respectively. Here, x(n) corresponds to x(n) in FIG. 1 (b), y(n+L) corresponds to y(n+L) at time n+L in FIG. 1 (b), then the state update mode of the reservoir and the output of the network are:

$$S ( n ) = tanh ( RS ( n - 1 ) + V x ( n ) )$$

$$y ( n + L ) = WS ( n )$$

Here, the network input data x(n) obtained by the feedforward microphone 103 at time n after passing through the analog-to-digital converter 108, the downsampling module 109 and the echo path filter 106 is used to predict the data y(n+L) collected by the feedback microphone 107 at time n+L through the downsampling module 109, which utilizes the prediction capability of the ESN network.

FIG. 1 (d) is the training procedure of an ESN network. Firstly, an initialization operation is performed to determine the size of a reservoir, i.e., the number of neurons. The more nodes there are, the stronger the fitting capability will be. Next, a random connection matrix is generated, representing which neurons are connected, their connection direction and weight, that is, matrix R in FIG. 1 (c). The subsequent scaling is a normalization operation, and a scaling factor may be directly used here. Under the influence of the adopted activation function tanh, weights are usually initialized to a value ranging from 0 to 1. Finally, an input weight V and an output weight W are randomly generated. These two parameters will affect the duration of the network's short-term memory. The smaller the input weight and the closer the spectral radius of the internal matrix is to 1, the longer the short-term memory duration of the network.

Next, the training is performed. An “idling” process in FIG. 1 (d) actually serves to initialize the state of the reservoir. Due to the random internal connections of the reservoir, the initial input sequences generate high-noise reservoir states, therefore, some data will be used first to initialize the state of the reservoir so as to reduce the influence of noise.

The final step of the training involves determining the output weight W using linear regression. Here, it is assumed that 2-norm regularization is applied to the output weight W with a regularization coefficient of λ. The network state matrix is S, and the output sequence matrix is Y, the optimization objective is as follows:

$$min {‖ WS - Y ‖}_{2}^{2} + λ {‖ W ‖}_{2}^{2}$$

Differentiate the above equation and set its derivative to 0. Based on the ridge regression least squares method, the solution can be derived as:

$$W = {{YS}^{T} ( {SS}^{T} + λ I )}^{- 1}$$

It can be seen from the training process that, the ESN network determines the output weight W through the linear regression least squares method, making the training steps simple and significantly lowering the computational complexity compared to RNNs, LSTMs, and other networks, which makes it highly suitable for online training and updating network parameters.

As shown in FIG. 1 (c), the processor 102 acquires the noise signal collected by the feedforward microphone 103 from the environment. After passing through the analog-to-digital converter 108 and the downsampling module 109, the processed noise signal is obtained. The noise signal is filtered by the trained neural network filter 104 containing an echo state network (ESN) to fit a nonlinear component in the ANC system 100 so as to obtain a first signal. The prediction function of the ESN network can be effectively used to compensate for the delay on the feedforward ANC path, so that the ANC path can have a wider noise cancellation bandwidth, thereby improving the effect of active noise cancellation. The first signal is processed by the upsampling module 110 to generate a noise cancellation signal, and the noise cancellation signal is adapted to be played via the speaker 105 to cancel residual noise in the ear. The ESN neural network has a relatively high prediction capability, which can not only compensate for the system delay, but also implement online training, so as to update the filtering parameters of the filter online, thereby achieving a relatively good active noise cancellation effect without the necessity of special cavity optimization of the earphone.

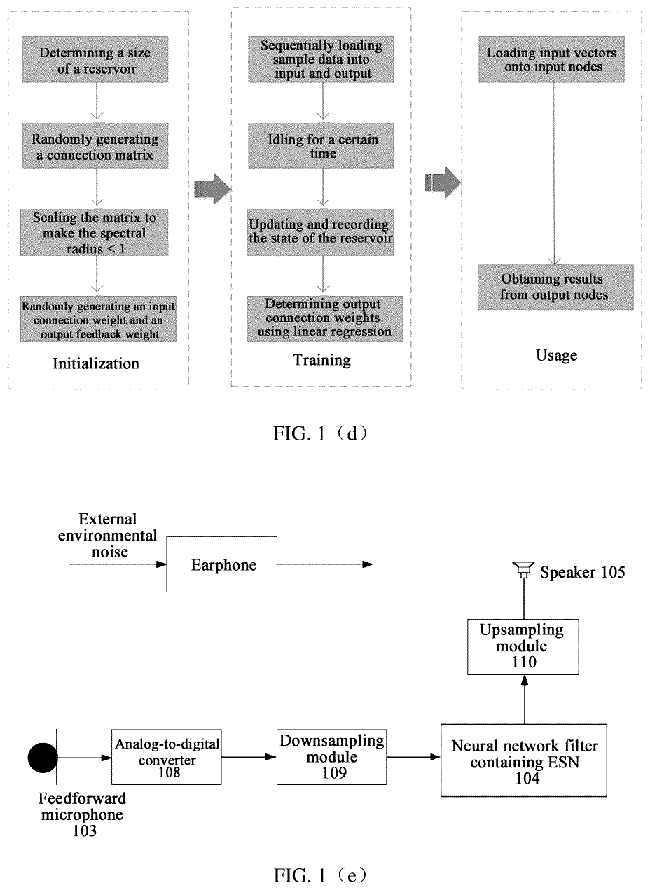

In some embodiments of the present disclosure, the processor is further configured to: after obtaining the noisy signal, fit the noisy signal using a preset IIR (Infinite Impulse Response) or FIR (Finite Impulse Response) linear filter, and then filter the fitted noise signal by the trained neural network filter containing the echo state network (ESN) to output a filtered second signal, and generate the noise cancellation signal based on the second signal. As shown in FIG. 2 (a), a noisy signal in the environment is collected by a feedforward microphone 201, and after being processed by an analog-to-digital converter 202 and a downsampling module 203, the processed noisy signal is obtained. Then, a preset IIR or FIR linear filter 204 is used to perform linear fitting on the processed noisy signal. In this way, it is beneficial to reduce the scale of the neural network. The noise signal after linear fitting is subjected to nonlinear fitting processing via a trained filter 205 containing the ESN, so that the filter 205 containing the ESN only fits the nonlinear part of the ANC system. On the basis of the preset IIR or FIR linear filter 204, the filter 205 containing the ESN is introduced to fit the nonlinear components in the ANC system, thereby achieving a better ANC effect. In this embodiment, in a training phase for training the neural network, as shown in FIG. 2 (b), an input x(n) to the neural network training 207 is a noisy signal collected by the feedforward microphone 201 and then processed by the preset IIR or FIR linear filter 204 and an echo path filter 206, and y(n) is a noisy signal collected by a feedback microphone 208 when the ANC function is not enabled.

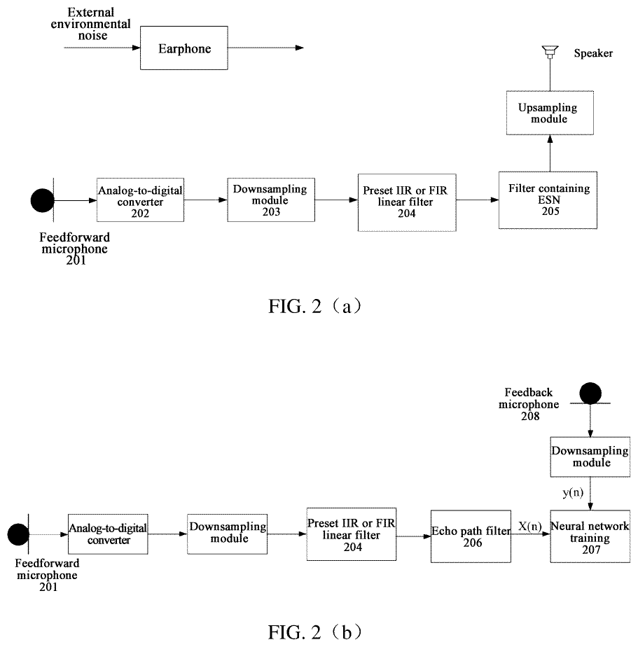

In some embodiments of the present disclosure, the processor is further configured to: obtain a noise residual signal collected by a feedback microphone and a third signal output via an echo path filter, adaptively and iteratively update coefficients of the FIR filter using the first signal, the third signal and the noise residual signal, filter the first signal using the FIR filter to output a filtered fourth signal, and generate the noise cancellation signal based on the fourth signal. Specifically, as shown in FIG. 3, the feedforward microphone 301 acquires noisy signals in the environment, which are processed by the analog-to-digital converter 302, the downsampling module 303, and then utilizes the ESN-containing filter 304 to firstly fit the nonlinear components in the ANC system to output a first signal. A feedback microphone 307 collects a noise residual signal in the earphone and transmits the noise residual signal to a FIR filter 305, and at the same time, the third signal output by an echo path filter 306 is also transmitted to the FIR filter 305. In this case, the filter coefficients of the FIR filter 305 are adaptively iterated using the first signal, the third signal, and the noise residual signal. Considering the high computational complexity of online training, the filter 304 comprising the ESN can be computed offline, or the coefficients of the ESN can be periodically updated(non-linear effects are caused by the electronics and do not generally change in real time). However, for the linear part, the adaptive FIR filter 305 may be used to update the linear coefficient parts closely related to the path change in real time according to the wearing condition of the earphone. The coefficient update process of the adaptive FIR filter 305 is as follows:

$$w ( n + 1 ) = w ( n ) + μ \frac{R ( n ) e ( n )}{{R}^{T} ( n ) R ( n )}$$

Where, w⁽ⁿ⁺¹⁾ represents a coefficient of the FIR filter 305 at the next time, and W(n) represents a coefficient of the FIR filter 305 at the current time, represented by a vector. w(n)=[w₀(n), w₁(n), w₂(n), . . . w_{L-1}(n)]^{T} is the length of the FIR filter 305. R(n)= [r(n), r(n−1), . . . , r(n−L+1)]^{T}, wherein, r(n) denotes a signal obtained by processing the noisy signal collected by the feedforward microphone 301 at the current time through the downsampling module 303, network processing via the ESN-containing filter 304, and filtering via the echo path filter 306. Here, e(n) represents a noise residual signal collected by the feedback microphone 307 at the current time, μ denotes the iterative step-size coefficient that is a constant, and n is the current sampling time. In this way, not only the noise cancellation bandwidth and the noise cancellation amount can be improved, but also linear fitting can be performed in real time according to the wearing condition of the earphone, thereby further improving the noise cancellation effect.

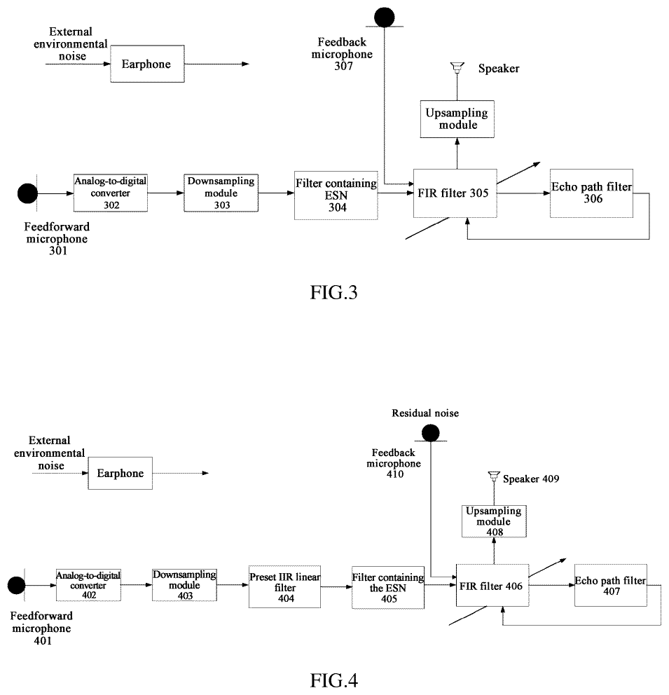

In some embodiments of the present disclosure, the processor is further configured to adaptively and iteratively update coefficients of the FIR filter using the second signal, the third signal, and the noise residual signal, filter the second signal using the FIR filter to output a filtered fifth signal, and generate the noise cancellation signal based on the fifth signal, thereby further improving the noise cancellation effect. Specifically, as shown in FIG. 4, similar to the foregoing, an external environmental noisy signal is collected by a feedforward microphone 401, and then processed by an analog-to-digital converter 402 and a downsampling module 403. The processed noise signal is filtered by a preset IIR linear filter 404, thereby facilitating the reduction of computational complexity of real-time self-adaptation. The filtered signal is input to a filter 405 containing the ESN for nonlinear fitting processing to output a filtered second signal, and linear fitting of a linear component in the ANC system is implemented in advance. A feedback microphone 410 collects a noise residual signal in the earphone and transmits the noise residual signal to a FIR filter 406, and at the same time, the third signal output by an echo path filter 407 is also transmitted to the FIR filter 406. Meanwhile, the filter coefficients of the FIR filter 406 are adaptively iteratively updated by using the second signal, the third signal, and the noise residual signal, and the second signal is filtered by the FIR filter to output a filtered fifth signal, After being processed by the upsampling module 408, a noise cancellation signal is generated, and the cancellation signal is played via the speaker 409 to cancel residual noise in the earphone. For the linear part, a combination scheme of the preset IIR filter 404 and the adaptive FIR filter 406 is adopted, which enables real-time updating of the linear coefficient part that is closely related to the path change according to the wearing condition of the earphone.

Here, a prediction function of the ESN network may be used to compensate for a delay on the feedforward ANC path. The noise signal is input into the ANC system, where it first undergoes delay compensation and nonlinear compensation via the filter 405 containing the ESN, then passes through the preset IIR linear filter 404 for linear filtering, and finally through the adaptive FIR filter 406 for adaptive linear filtering, so that the complexity of network calculation of the filter 405 containing the ESN can be reduced. The ESN network for delay compensation may be trained offline or may be trained online and updated periodically. By combining the linear filter with the filter containing the neural network, the fitting accuracy of the ANC system is improved, the scale of the neural network is reduced as much as possible, the computational complexity is reduced, and the noise cancellation bandwidth and noise cancellation amount of the ANC system can be improved. The prediction function of the neural network with the prediction function is used to predict the noise cancellation data, which can also compensate for the processing delay of the system and further improve the noise cancellation effect.

In some embodiments of the present disclosure, an in-ear or out-of-ear state of the earphone is obtained, and when the earphone is in the in-ear state, if a change in the wearing manner or the leakage amount occurs, the ESN is retrained locally. For example, when it is detected that the earphone has an in-ear action or is already in the ear, if a change in the wearing manner or the leakage amount occurs, the ESN may be retrained locally to update the filtering parameter of the adaptive filter, thereby achieving a better noise cancellation effect. The method for detecting the wearing manner or leakage amount of the earphone after it is put into the ear is not limited, and methods disclosed in the prior art can be adopted for implementation.

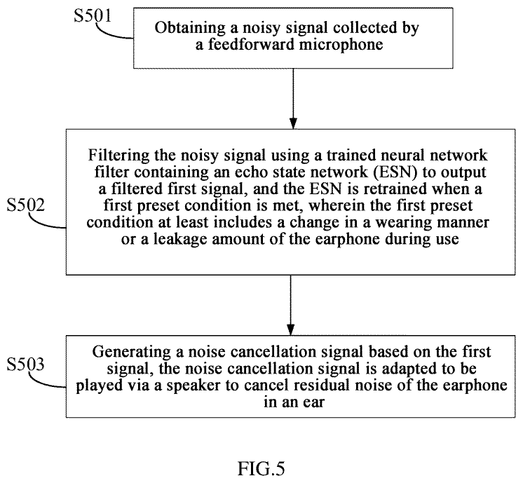

FIG. 5 is a flowchart of a noise cancellation method for an ANC system according to an embodiment of the present disclosure. In step S501, a noisy signal collected by a feedforward microphone is obtained. In step S502, the noisy signal is filtered by a trained neural network filter containing an ESN to output a filtered first signal, and the ESN is retrained when a first preset condition is met. Wherein the first preset condition at least includes a change in a wearing manner or a leakage amount of an earphone during use. In step S503, a noise cancellation signal is generated based on the first signal, and the noise cancellation signal is adapted to be played via a speaker to cancel residual noise of the earphone in an ear.

In some embodiments of the present disclosure, after the noisy signal is obtained, the noisy signal is fitted using a preset IIR or FIR linear filter, and then the fitted noisy signal is filtered by the trained neural network filter containing the echo state network (ESN) to output a filtered second signal, and the noise cancellation signal is generated based on the second signal.

In some embodiments of the present disclosure, a noise residual signal collected by a feedback microphone and a third signal output via an echo path filter are obtained. Coefficients of the FIR filter are adaptively and iteratively updated using the first signal, the third signal, and the noise residual signal, and the first signal is filtered using the FIR filter to output a filtered fourth signal, and the noise cancellation signal is generated based on the fourth signal.

In some embodiments of the present disclosure, the coefficients of the FIR filter are adaptively and iteratively updated using the second signal, the third signal, and the noise residual signal, the second signal is filtered using the FIR filter to output a filtered fifth signal, and the noise cancellation signal is generated based on the fifth signal.

In some embodiments of the present disclosure, a computer-readable storage medium is provided. The computer-readable storage medium stores computer program instructions that, when executed by a processor, enable the processor to perform the noise cancellation method according to various embodiments of the present disclosure. The implementation of such methods can include software code, such as microcode, assembly language code, a higher-level language code, or the like. Various programs or program modules can be created using various software programming techniques. For example, program portions or program modules may be designed in or via Java, Python, C, C++, assembly language, or any known programming language. One or more of such software portions or modules may be integrated into a computer system and/or computer-readable media. Such software code can comprise computer-readable instructions for performing various methods. The software code may form part of computer program products or computer program modules. Further, in an example, the software code may be tangibly stored on one or more volatile, non-transitory, or non-volatile tangible computer-readable media, such as during execution or at other times. Examples of these tangible computer-readable media can include, but are not limited to, hard disks, removable magnetic disks, removable optical discs (e.g., compact discs and digital video discs), magnetic cassettes, memory cards or memory sticks, random access memories (RAMs), read only memories (ROMs), and the like.

Furthermore, although exemplary embodiments have been described herein, their scope includes any and all embodiments based on the present disclosure that have equivalent elements, modifications, omissions, combinations (e.g., schemes where various embodiments intersect), adaptations, or changes. The elements in the claims are to be broadly interpreted based on the language adopted in the claims, and are not limited to the examples described in this specification or during the implementation of this application, and the examples thereof are to be interpreted as non-exclusive. Therefore, this specification and examples are intended to be regarded as examples only, with the true scope and spirit indicated by the claims and the full scope of their equivalents.

The above description is intended to be illustrative rather than limiting. For example, the above examples (or one or more aspects thereof) can be used in combination with each other. For example, one of ordinary skill in the art can use other embodiments when reading the above description. In addition, in the above specific embodiments, various features can be grouped together to simplify the present disclosure. This should not be interpreted as an intention that an unclaimed disclosed feature is necessary for any claim. On the contrary, the subject matter of the present disclosure may be less than all the features of certain disclosed embodiments. Therefore, the claims are incorporated into the detailed description as examples or embodiments, in which each claim independently serves as a separate embodiment, and it is considered that these embodiments can be combined with each other in various combinations or arrangements. The scope of the present disclosure should be determined with reference to the appended claims and the full scope of equivalents to which these claims are entitled.

The above embodiments are merely exemplary embodiments of the present disclosure and are not intended to limit the present disclosure, and the protection scope of the present disclosure is defined by the claims. A person skilled in the art may make various modifications or equivalent substitutions to the present disclosure within the spirit and protection scope of the present disclosure, and such modifications or equivalent substitutions should also be considered as falling within the protection scope of the present disclosure.

What is claimed is:

1. An active noise cancellation (ANC) system for an earphone, wherein the ANC system comprises a system-on-chip comprising a processor configured to:
obtain a noisy signal collected by a feedforward microphone;
filter the noisy signal using a trained neural network filter containing an echo state network (ESN) to output a filtered first signal, and retrain the ESN when a first preset condition is met, wherein the first preset condition at least includes a change in a wearing manner or a leakage amount of the earphone during use; and
generate a noise cancellation signal based on the first signal, the noise cancellation signal being adapted to be played via a speaker to cancel residual noise of the earphone in an ear.

2. The ANC system according to claim 1, wherein the processor is further configured to: after obtaining the noisy signal, fit the noisy signal using a preset infinite impulse response (IIR) or finite impulse response (FIR) linear filter, and then filter the fitted noisy signal using the trained neural network filter containing the echo state network (ESN) to output a filtered second signal, and generate the noise cancellation signal based on the second signal.

3. The ANC system according to claim 2, wherein the processor is further configured to:
obtain a noise residual signal collected by a feedback microphone and a third signal output via an echo path filter; and
adaptively and iteratively update coefficients of a FIR filter using the first signal, the third signal, and the noise residual signal, filter the first signal using the FIR filter to output a filtered fourth signal, and generate the noise cancellation signal based on the fourth signal.

4. The ANC system according to claim 3, wherein the processor is further configured to: adaptively and iteratively update coefficients of a FIR filter using the second signal, the third signal, and the noise residual signal, filter the second signal using the FIR filter to output a filtered fifth signal, and generate the noise cancellation signal based on the fifth signal.

5. The ANC system according to claim 1, wherein an in-ear state or out-of-ear state of the earphone is obtained, and when the earphone is in the in-ear state and a change in the wearing manner or the leakage amount occurs, the ESN is retrained locally.

6. A noise cancellation method for an active noise cancellation (ANC) system, comprising:
obtaining a noisy signal collected by a feedforward microphone;
filtering the noisy signal using a trained neural network filter containing an echo state network (ESN) to output a filtered first signal, and retraining the ESN when a first preset condition is met, wherein the first preset condition at least includes a change in a wearing manner or a leakage amount of an earphone during use; and
generating a noise cancellation signal based on the first signal, the noise cancellation signal being adapted to be played via a speaker to cancel residual noise of the earphone in an ear.

7. The noise cancellation method according to claim 6, further comprising:
after obtaining the noisy signal, fitting the noisy signal using a preset infinite impulse response (IIR) or finite impulse response (FIR) linear filter, and then filtering the fitted noisy signal using the trained neural network filter containing the echo state network (ESN) to output a filtered second signal, and generating the noise cancellation signal based on the second signal.

8. The noise cancellation method according to claim 7, further comprising:
obtaining a noise residual signal collected by a feedback microphone and a third signal output via an echo path filter; and
adaptively and iteratively updating coefficients of the FIR filter using the first signal, the third signal, and the noise residual signal, filtering the first signal using the FIR filter to output a filtered fourth signal, and generating the noise cancellation signal based on the fourth signal.

9. The noise cancellation method according to claim 8, further comprising:
adaptively and iteratively updating coefficients of the FIR filter using the second signal, the third signal, and the noise residual signal, filtering the second signal using the FIR filter to output a filtered fifth signal, and generating the noise cancellation signal based on the fifth signal.

10. A computer-readable storage medium, wherein the computer-readable storage medium stores computer program instructions that, when executed by a processor, enable the processor to perform a noise cancellation method as follows:
obtaining a noisy signal collected by a feedforward microphone;
filtering the noisy signal using a trained neural network filter containing an echo state network (ESN) to output a filtered first signal, and retraining the ESN when a first preset condition is met, wherein the first preset condition at least includes a change in a wearing manner or a leakage amount of an earphone during use; and
generating a noise cancellation signal based on the first signal, the noise cancellation signal being adapted to be played via a speaker to cancel residual noise of the earphone in an ear.

11. The computer-readable storage medium according to claim 10, wherein the method further comprises:
after obtaining the noisy signal, fitting the noisy signal using a preset infinite impulse response (IIR) or finite impulse response (FIR) linear filter, and then filtering the fitted noisy signal using the trained neural network filter containing the echo state network (ESN) to output a filtered second signal, and generating the noise cancellation signal based on the second signal.

12. The computer-readable storage medium according to claim 11, wherein the method further comprises:
obtaining a noise residual signal collected by a feedback microphone and a third signal output via an echo path filter; and
adaptively and iteratively updating coefficients of the FIR filter using the first signal, the third signal, and the noise residual signal, filtering the first signal using the FIR filter to output a filtered fourth signal, and generating the noise cancellation signal based on the fourth signal.

13. The computer-readable storage medium according to claim 12, wherein the method further comprises:
adaptively and iteratively updating coefficients of the FIR filter using the second signal, the third signal, and the noise residual signal, filtering the second signal using the FIR filter to output a filtered fifth signal, and generating the noise cancellation signal based on the fifth signal.
